(19) United States
(12) Patent Application Publication
(10) Pub. No.: US 2026/0137495 A1
(43) Pub. Date: May 21, 2026

(54) MOTOR AND ORAL CLEANING DEVICE

(71) Applicant: Shenzhen Soocas Technology Co., Ltd., Shenzhen (CN)

(72) Inventors: Mengwei ZENG, Shenzhen (CN); Yanqiang LI, Shenzhen (CN); Yi XIE, Shenzhen (CN); Zhoujian LI, Shenzhen (CN)

(73) Assignee: Shenzhen Soocas Technology Co., Ltd., Shenzhen (CN)

(21) Appl. No.: 19/428,126

(22) Filed: Dec. 20, 2025

Related U.S. Application Data
(63) Continuation of application No. PCT/CN2025/114232, filed on Aug. 12, 2025.

(30) Foreign Application Priority Data
Nov. 20, 2024 (CN) 202411670207X

(51) Int. Cl. A61C 17/34; A46B 13/02

(52) U.S. Cl. CPC A61C 17/34; A46B 13/02

(57) ABSTRACT

Embodiments of the present disclosure disclose a motor and an oral cleaning device. The motor includes a stator assembly and a rotor assembly. The stator assembly includes at least one pair of stator cores. The rotor assembly includes a power shaft and magnet assemblies. The stator cores, in an energized state, can drive the rotor assembly to oscillate back and forth. When the stator assembly is not powered on and the rotor assembly is not subjected to an external force, the rotor assembly is at a balanced position. The rotor assembly is at an unbalanced position when being subjected to an external force, and a rotatable angle of the rotor assembly when being subjected to the external force is greater than 360°. When the external force is removed, the rotor assembly is reset to the balanced position under the action of a cogging torque.

### CROSSREFERENCE TO RELATED APPLICATION

This application is a continuation of International Application No. PCT/CN2025/114232, filed on August 12, 2025, which claims priority to Chinese Patent Application No.202411670207X, titled "MOTOR AND ORAL CLEANING DEVICE" and filed to the China National Intellectual Property Administration on November 20, 2024, the entire contents of which are incorporated herein by reference.

### TECHNICAL FIELD

The present disclosure relates to the technical field of oral cleaning devices, and more particularly, to a motor used in an oral cleaning device, and an oral cleaning device.

### BACKGROUND

In an oral cleaning device, an output shaft of a motor is typically connected to a brush head to drive the brush head to perform a cleaning operation during the operation of the oral cleaning device. Because the brush head is connected to the output shaft of the motor, the brush head can rotate only within a relatively small fixed range when being subjected to an external force, resulting in poor user convenience.

On this basis, how to provide an oral cleaning device that can improve user convenience has become an urgent technical problem to be solved.

### SUMMARY

The present disclosure proposes a motor for use in an oral cleaning device, and an oral cleaning device to solve the technical problem of poor user convenience of existing motors and oral cleaning devices.

A motor for use in an oral cleaning device includes: a stator assembly and a rotor assembly.

The stator assembly is configured to generate a magnetic field, and the stator assembly comprises at least one pair of stator cores uniformly distributed in a circumferential direction.

The rotor assembly is at least partially arranged within the magnetic field of the stator assembly, and the rotor assembly comprises a power shaft and magnet assemblies arranged on the power shaft and matching the stator cores.

The stator cores are configured to drive, in an energized state, the rotor assembly to oscillate back and forth at a predetermined angle; and in a de-energized state, the rotor assembly is configured to have a rotatable angle greater than 360° when being subjected to an external force.

The rotor assembly has a balanced position matching the stator cores and an unbalanced position deviating from the stator cores; and at the unbalanced position, the rotor assembly is configured to reset to the balanced position under an action of a cogging torque after the external force is removed.

Optionally, number of the balanced positions is configured to correspond to number of the stator cores; the balanced position at least comprises a first balanced position and a second balanced position corresponding to one pair of stator cores, respectively.

When at the unbalanced position, the magnet assemblies are configured to reset towards the first balanced position or the second balanced position having a minimum angle according to an angle between a current position and the first balanced position or the second balanced position.

Optionally, the stator assembly comprises two of the stator cores, the two stator cores being mirror-symmetrical; and the rotor assembly comprises two groups of magnet assemblies, the two groups of magnet assemblies being mirror-symmetrical.

Optionally, an angle between the first balanced position and the second balanced position is configured to be a first angle, and the first angle ranges from 180°-3° to 180°+3°.

Optionally, the magnet assemblies comprise a first magnet and a second magnet, and the first magnet and the second magnet are spaced apart on the power shaft.

Optionally, the first magnet and the second magnet are both in a circular arc shape, and comprise an outside circular arc and an inside circular arc distributed in a radial direction, and two side edges connecting two corresponding ends of the outside circular arc and the inside circular arc, respectively.

Optionally, the first magnet and the second magnet are arranged along a circumferential direction of the power shaft, a central angle corresponding to a spacing between the first magnet and the second magnet is a second angle, and the second angle ranges from 23.5° to 38°.

Optionally, within a plane perpendicular to an axis of rotation of the rotor assembly, a third angle between a centerline of the first magnet and a centerline of the second magnet ranges from 73° to 87°, where the centerline of the first magnet is a centerline pointing from a center of the first magnet to the axis of rotation of the rotor assembly, and the centerline of the second magnet is a centerline pointing from a center of the second magnet to the axis of rotation.

Optionally, within a plane perpendicular to an axis of rotation of the rotor assembly, a ratio of a first central angle corresponding to the outside circular arc of the first magnet facing the stator core to a second central angle corresponding to an inner circular arc of the stator core facing the magnet assembly ranges from 60% to 85%.

Optionally, within a plane perpendicular to an axis of rotation of the rotor assembly, a ratio of a third central angle corresponding to the outside circular arc of the second magnet facing the stator core to a second central angle corresponding to an inner circular arc of the stator core facing the magnet assembly ranges from 60% to 85%.

Optionally, the motor further comprises an output shaft, where one end of the output shaft is connected to a brush head of an electric toothbrush.

The embodiments of the present disclosure also provide an oral cleaning device, which has the motor.

### BRIEF DESCRIPTION OF THE DRAWINGS

To describe the technical solutions of the embodiments of the present disclosure or those of the prior art more clearly, the accompanying drawings required for describing the embodiments or the prior art will be briefly introduced below. Apparently, the accompanying drawings in the following description are merely some embodiments recorded in the present disclosure. To those of ordinary skills in the art, other accompanying drawings may also be derived from these accompanying drawings without creative efforts.

FIG. 1 is a schematic diagram of an internal structure of a motor according to an embodiment of the present disclosure;

FIG. 2 is a schematic diagram of an overall structure of a motor according to an embodiment of the present disclosure;

FIG. 3 is a schematic structural diagram of a power shaft according to an embodiment of the present disclosure;

FIG. 4 is a schematic structural diagram of a magnet according to an embodiment of the present disclosure;

FIG. 5 is a schematic structural diagram of a first central angle and a third central angle according to an embodiment of the present disclosure;

FIG. 6 is a schematic structural diagram of a second angle according to an embodiment of the present disclosure;

FIG. 7 is a schematic structural diagram of a third angle according to an embodiment of the present disclosure;

FIG. 8 is a schematic structural diagram of a fifth angle according to an embodiment of the present disclosure;

FIG. 9 is a schematic structural diagram of a second central angle according to an embodiment of the present disclosure;

FIG. 10 is a schematic structural diagram of a fourth central angle according to an embodiment of the present disclosure;

FIG. 11 is a schematic diagram of distribution of simulation data of a cogging torque of a motor according to an embodiment of the present disclosure; and

FIG. 12 is a schematic diagram of distribution of simulation data of a motor torque according to an embodiment of the present disclosure.

Reference numerals in the accompanying drawings: stator assembly 1; stator core 11; rotor assembly 2; power shaft 21; rotor core 211; mounting slot 2111; output shaft 212; magnet assembly 22; first magnet 221; outside circular arc 2211; inside circular arc 2212; side edge 2213; second magnet 222; first central angle 223; second angle 224; third angle 225; fourth angle 226; second central angle 227; third central angle 228; fifth angle 229; fourth central angle 230; fifth central angle 231; motor housing 3; electromagnetic coil 4; and air gap 5.

### DETAILED DESCRIPTION

To make objectives, technical solutions and advantages of one or more embodiments of this specification clearer, the technical solutions of one or more embodiments of the present disclosure will be described clearly and completely below in conjunction with the specific embodiments of this specification and the corresponding drawings. Apparently, the described embodiments are some but not all of the embodiments of the present disclosure. All other embodiments obtained by those of ordinary skills in the art based on the embodiments of this specification without creative efforts shall fall within the protection scope of the one or more embodiments of this specification.

A motor is provided. The motor may be used in an oral cleaning or care device such as an electric toothbrush. Of course, the motor may also be used in other electronic devices that require reciprocating oscillation, which are not to be enumerated one by one herein. The motor in the embodiments of the present disclosure may include a motor body, and a stator assembly and a rotor assembly arranged on the motor body.

The stator assembly is arranged on the motor body and is configured to generate a magnetic field. The stator assembly includes at least one pair of stator cores, which may be fixed on the motor body to provide the magnetic field to the motor. The stator cores may be provided in one pair, or in two or more pairs. The stator cores are typically uniformly arranged in a circumferential direction of the rotor assembly to facilitate reciprocating oscillation of the rotor assembly, etc. The rotor assembly may include a power shaft and magnet assemblies arranged on the power shaft and matching the stator cores. The rotor assembly, in an energized state, can oscillate back and forth at a predetermined angle; and in a de-energized state, the rotor assembly has a rotatable angle greater than 360° when being subjected to an external force. The rotor assembly has a balanced position matching the stator cores and an unbalanced position deviating from the stator cores. Under the action of the external force, the rotor assembly may be at the unbalanced position; and the rotor assembly may reset to the balanced position under the action of a cogging torque after the external force is removed.

In the prior art, with the development of the industry, a handle of the oral cleaning device may be provided with an electronic display region, and the electronic display region may be used for displaying some prompt information about a user's oral cleaning situations, such as missed brushing prompt information, overpressure prompt information, and brushing duration prompt information, to remind the user. At present, a brush head of the oral cleaning device can sweep or rotate only within a fixed range, such that orientation of a brush bristle region on the brush head is fixed with a direction of the electronic display region. For example, the orientation of the brush bristle region may be on the same side as the electronic display region. At this moment, when the user wants to view the prompt information in the electronic display region during oral cleaning, the user needs to stop brushing teeth to view the prompt information, resulting in poor convenience for use. To solve the defects in the prior art, this solution provides the following embodiments.

The technical solutions provided in the embodiments of the present disclosure are described in detail below with reference to the accompanying drawings.

The embodiments of the present disclosure provide a motor used in an oral cleaning device, such that the oral cleaning device can operate on the basis of the motor to clean teeth and gums, thereby protecting oral health.

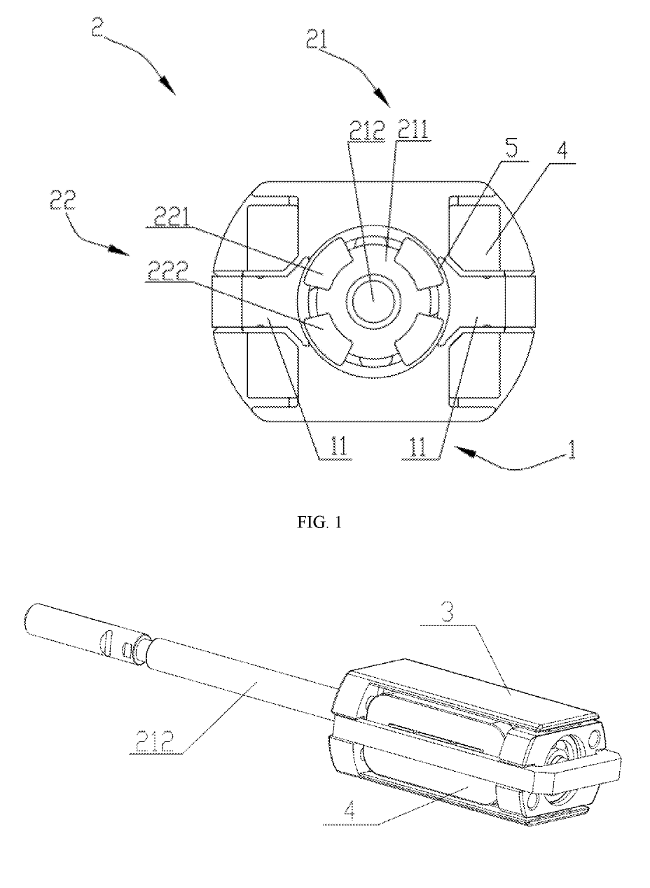

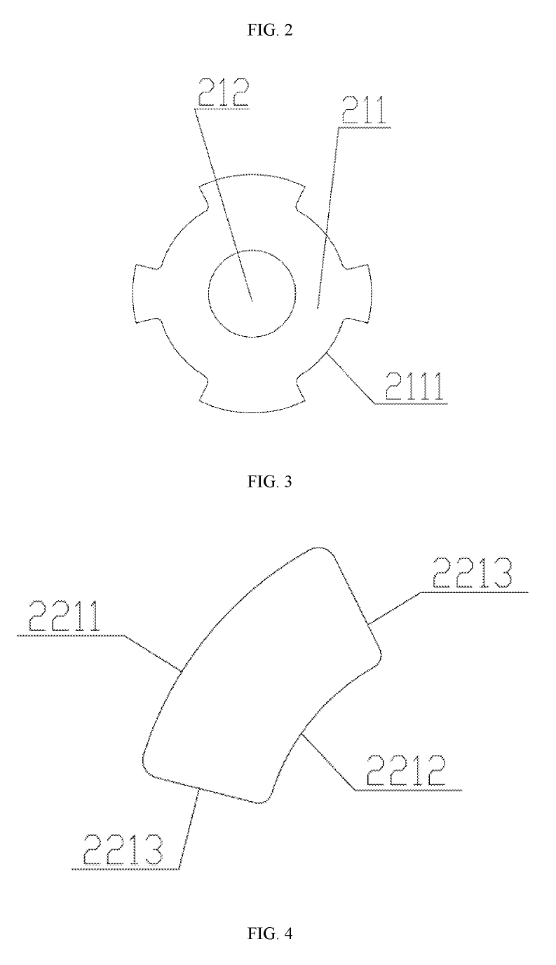

FIG. 1 is a schematic diagram of an internal structure of a motor according to an embodiment of the present disclosure; and FIG. 2 is a schematic diagram of an overall structure of a motor according to an embodiment of the present disclosure. As shown in FIG. 1 and FIG. 2, the motor may include a stator assembly 1, a rotor assembly 2, a motor housing 3, and an electromagnetic coil 4. There is also an air gap 5 between the rotor assembly 2 and the stator assembly 1.

The stator assembly 1 may be integrally injection molded and embedded on two sides of the motor housing 3, while the rotor assembly 2 may be mounted inside motor housing 3. The stator assembly 1 may coaxially fit with the rotor assembly 2. The stator assembly 1 does not require manual secondary assembly, which can yield a relatively small concentricity tolerance between the stator assembly 1 and the rotor assembly 2, thereby effectively reducing cumulative tolerance generated during assembly of the motor, reducing vibration generated by rotation of the rotor assembly 2, and reducing noises generated during operation of the motor. The electromagnetic coil 4 is arranged around the stator cores 11, and responds to a control signal applied to the electromagnetic coil 4.

In the embodiments of the present disclosure, the stator assembly 1 may include one or more pairs of stator cores 11 uniformly distributed in a circumferential direction, and the electromagnetic coil 4 arranged around the stator cores 11. When the electromagnetic coil 4 is energized, the stator assembly 1 may generate a magnetic field. Specifically, in the energizing process, the stator assembly may generate an alternating magnetic field. By changing the magnetic field, the rotor assembly corresponding to the stator cores may be controlled to perform reciprocating motion according to a change frequency of the magnetic field.

In practical applications, a silicon steel sheet having a high magnetic permeability may be used as a material for the stator cores 11. As an alloy material, the silicon steel sheet is mainly comprised of silicon, carbon, and iron, and has excellent magnetic conductivity and corrosion resistance. In addition to the silicon steel sheet, the stator cores 11 may also be made of materials such as aluminum alloy and copper nickel alloy.

The rotor assembly 2 may include a power shaft 21 and magnet assemblies 22 arranged along a circumferential direction of the power shaft 21, where the magnet assemblies 22 match the stator cores 11.

FIG. 3 is a schematic structural diagram of the power shaft according to an embodiment of the present disclosure. As shown in FIG. 3, the power shaft 21 may include a rotor core 211 and an output shaft 212 arranged in a center of the rotor core 211. The output shaft 212 may be used for connecting an operating component of the oral cleaning device, such as a brush head of a toothbrush or a nozzle of an oral irrigator, and driving the operating component of the oral cleaning device to clean teeth and gums.

The rotor assembly 2 is at least partially positioned within the magnetic field generated by the stator assembly 1, such that the rotor assembly 2 may vibrate back and forth at a predetermined angle under the action of the magnetic field generated by energizing the stator assembly 1, thereby driving the brush head to perform an oral cleaning operation.

When the stator assembly 1 is in a de-energized state, the rotor assembly 2 may have a balanced position matching the stator cores 11. The rotor assembly 2 may be at the balanced position when being not subjected to an external force. The balanced position may be a position where the rotor assembly 2 is in a stationary state relative to the stator assembly 1. The rotor assembly at the balanced position can ensure normal start of the motor. In practical applications, the number of the balance positions corresponds to the number of the stator cores 11. For example, when the stator assembly 1 only includes one pair of stator cores 11, the rotor assembly 2 may include two balanced positions, and the two balanced positions may be a first balanced position and a second balanced position, respectively. Herein, two stator cores in one pair of stator cores 11 may be mirror-symmetrical, and a first angle between the first balanced position and the second balanced position may range from 180°-3° to 180°+3°.

In addition, when being subjected to the external force, the rotor assembly 2 may also be at the unbalanced position under the action of the external force. The motor in the embodiments of the present disclosure is not provided with a limiting structure, such that a rotatable angle of the rotor assembly 2 under the action of the external force may be greater than 360°. That is, the rotatable angle of the rotor assembly 2 under the action of the external force may be an arbitrary value. When the external force is removed, the rotor assembly 2 may be reset to the balanced position under the action of a cogging torque. Specifically, the balanced position where the rotor assembly 2 is reset may be determined according to an angle between a current unbalanced position and the first balanced position or the second balanced position. For example, when the external force is removed, the rotor assembly 2 may be reset towards the first balanced position or the second balanced position having a minimum angle.

In the embodiments of the present disclosure, because the rotor assembly 2 may rotate at any angle under the action of the external force, the user may manually rotate the brush head to any desired balanced position or to the vicinity of the balanced position as needed. For example, when the brush bristle region on the brush head of the oral cleaning device is positioned on the same side as the electronic display region, it is to be understood that the rotor assembly 2 is at one of the balanced positions. When the rotor assembly is at this balanced position, if the user wants to view information in the electronic display region during toothbrushing, the user can only stop the toothbrushing operation first and take out the oral cleaning device from mouth to view the information. If the user feels inconvenient, the user may manually rotate the brush head by 180°, such that the brush bristle region and the electronic display region face different sides. At this moment, the user may view the prompt information displayed in the electronic display region from a mirror, avoiding the user from stopping toothbrushing and not affecting the toothbrushing process of the user, thereby meeting the user's needs and improving the convenience for the user in using the oral cleaning device. It is to be understood that after the user manually rotates the brush head by 180°, the rotor assembly 2 is at another balanced position.

In the embodiments of the present disclosure, the rotor assembly 2 may include two groups of magnet assemblies 22, which may be mirror-symmetrical. Any group of magnet assemblies 22 may include a first magnet 221 and a second magnet 222, and the first magnet 221 and the second magnet 222 may be spaced apart on the power shaft 21. Specifically, the first magnet 221 and the second magnet 222 may be spaced apart on the rotor core 211 of the power shaft 21, such that the magnetic field is relatively uniformly distributed on the rotor assembly 2, thereby reducing the cogging torque. When an output torque of the motor remains unchanged, a swing angle may be increased to prolong drive time of a single period, thereby reducing a frequency at which the rotor assembly 2 drives the brush head to swing, and improving experience of the user in using the oral cleaning device provided with the motor.

In the embodiments of the present disclosure, the rotor core 211 is also provided with mounting slots 2111 for mounting the magnet assemblies 22. Specifically, magnets in the magnet assemblies 22 may be embedded into the mounting slots by means of an adhesive, where the adhesive may be glue, etc. The magnets in the magnet assemblies 22 may also be placed in the mounting slots by means of welding. The first magnet 221 and the second magnet 222 in the magnet assemblies 22 may be embedded in different mounting slots, respectively, such that the magnets in the magnet assemblies 22 may be fixed in the mounting slots, preventing the magnet assemblies 22 from falling off from the mounting slots, thus avoiding adversely affecting normal operation of the motor.

In the embodiments of the present disclosure, a corresponding number of the mounting slots may be set on the basis of the number of the magnet assemblies 22. Preferably, the number of the magnet assemblies 22 may be two groups, and correspondingly, the number of the mounting slots may be four.

FIG. 4 is a schematic structural diagram of a magnet according to an embodiment of the present disclosure. As shown in FIG. 4, in the embodiments of the present disclosure, cross-sections of the first magnet 221 and the second magnet 222 may be in a circular arc shape. Specifically, both the first magnet 221 and the second magnet 222 may include an outside circular arc 2211 and an inside circular arc 2212 distributed in a radial direction, and two side edges 2213 connecting two endpoints of the outside circular arc 2211 and the inside circular arc 2212 on the same side, respectively. A central angle corresponding to the outside circular arc 2211 is the same as a central angle corresponding to the inside circular arc 2212. The central angle corresponding to the outside circular arc 2211 may be an angle between two first connecting line segments formed by connecting the two endpoints of the outside circular arc 2211 to a center of the power shaft 21, respectively. The central angle corresponding to the inside circular arc 2212 may be an angle between two second connecting line segments formed by connecting the two endpoints of the inside circular arc 2212 to the center of the power shaft 21, respectively. It is to be understood that the two first connecting line segments and the two side edges 2213 may have overlapping portions, and the two second connecting line segments and the two side edges 2213 may also have overlapping portions. The circular arc shape of the magnets can better match the shape of the air gap 5 between the rotor assembly 2 and the stator assembly 1, which helps to generate a more uniform magnetic field distribution, thereby reducing vibration and noise caused by a nonuniform magnetic field.

During actual construction of the motor, a width of the air gap 5 between the outside circular arc 2211 of the first magnet 221 or the second magnet 222 and an inner circular arc of the stator core 11 facing the magnet assembly 22 may range from 0.15 millimeters to 0.25 millimeters, which may improve degree of fit between the rotor assembly 2 and the stator assembly 1 without adversely affecting the normal operation of the rotor assembly 2.

In the embodiments of the present disclosure, a thickness of the first magnet 221 and a thickness of the second magnet 222 may both be set within a predetermined thickness range, where the predetermined thickness range may be 1 millimeter to 2 millimeters. The thickness of the first magnet 221 and the thickness of the second magnet 222 may be a radial distance between the outside circular arc 2211 and the inside circular arc 2212. It is to be understood that the radial distance between the outside circular arc 2211 and the inside circular arc 2212 may represent the shortest distance between the outside circular arc 2211 and the inside circular arc 2212. Preferably, both the thickness of the first magnet 221 and the thickness of the second magnet 222 may be set to 1.5 millimeters. A depth of the mounting slot may be set to 0.7 millimeters. A distance between a bottom of the mounting slot and an axis of rotation may be set to 2.5 millimeters. A distance between the outside circular arc 2211 of the magnet in the magnet assembly 22 and the axis of rotation is 4 millimeters. It is to be understood that the magnet in the magnet assembly 22 is partially exposed outside the mounting slot to enhance the degree of fit between the rotor assembly 2 and the stator assembly 1.

In practical applications, both the thickness of the first magnet 221 and the thickness of the second magnet 222 may be set to 1.2 millimeters, 1.8 millimeters, etc. The thickness of the first magnet 221 and the thickness of the second magnet 222 may be determined on the basis of a spatial distance between the power shaft 21 and the stator assembly 1. An appropriate thickness of the magnet may be selected to ensure that a certain gap is provided between the magnet and the stator assembly after the magnet is arranged on the power shaft, and the magnetic field generated by the magnet can also meet preset requirements, thereby reducing the cogging torque, increasing the swing angle, and reducing the frequency without adversely affecting the rotation of the rotor assembly 2.

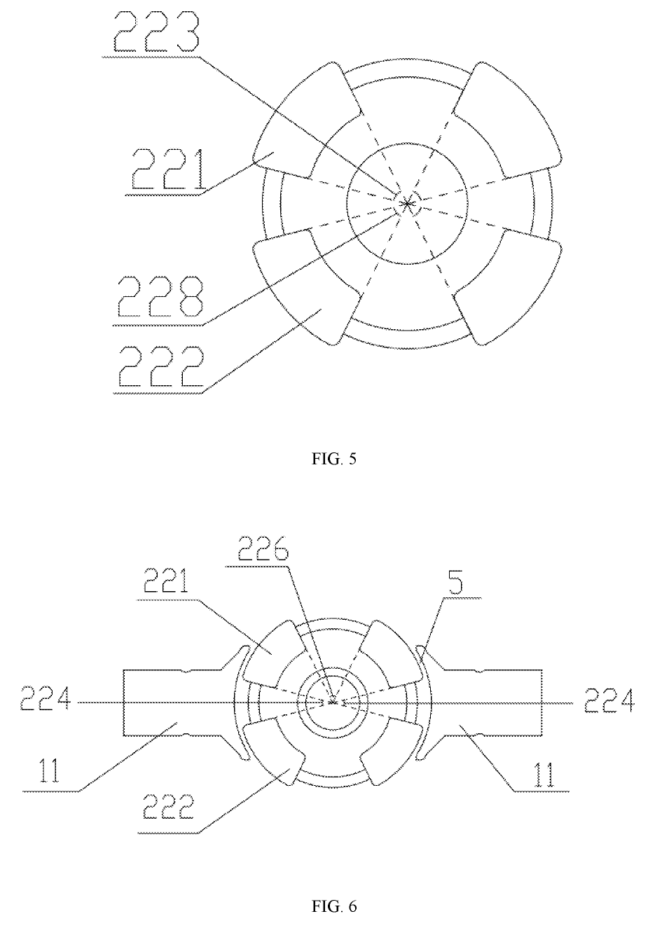

FIG. 5 is a schematic structural diagram of a first central angle and a third central angle according to an embodiment of the present disclosure. As shown in FIG. 5, in the embodiments of the present disclosure, a central angle corresponding to the outside circular arc 2211 of the first magnet 221 and a central angle corresponding to the inside circular arc 2212 may be a first central angle 223, and the first central angle 223 may range from 42° to 57°. A central angle corresponding to the outside circular arc 2211 of the second magnet 222 and a central angle corresponding to the inside circular arc 2212 may be a third central angle 228, and the third central angle 228 may range from 42° to 57°. Specifically, both the first magnet 221 and the second magnet 222 may be magnets having a central angle of 49.5° corresponding to the outside circular arc 2211 and a central angle of 49.5° corresponding to the inside circular arc 2212, or may also be magnets having a central angle of 45° corresponding to the outside circular arc 2211 and a central angle of 45° corresponding to the inside circular arc 2212, or may also be magnets having a center angle of 54° corresponding to the outside circular arc 2211 and a central angle of 54° corresponding to the inside circular arc 2212.

FIG. 6 is a schematic structural diagram of a second angle according to an embodiment of the present disclosure. As shown in FIG. 6, in the embodiments of the present disclosure, a central angle corresponding to a circumferential spacing between the first magnet 221 and the second magnet 222 on the power shaft 21 may be a second angle 224, and the second angle 224 may be an angle between a first connecting line segment and a second connecting line segment having a short distance among the first connecting line segments and the second connecting line segments. The second angle 224 may range from 23.5° to 38°. Specifically, the central angle corresponding to the spacing between the first magnet 221 and the second magnet 222 in one group of magnet assemblies 22 may be 25°, 27°, 30.5°, or 34.4°, etc. It is to be understood that when the rotor assembly 2 is constructed, the spacing between the first magnet 221 and the second magnet 222 may be reasonably set to make the magnetic field generated by magnet assembly 22 more uniform, thereby reducing the cogging torque, increasing the swing angle, and reducing the rotor frequency.

In addition, a fourth angle 226 between the two groups of magnet assemblies 22 may be greater than the second angle 224 between the first magnet 221 and the second magnet 222 in the magnet assembly 22. Thus, one stator core 11 and one magnet assembly 22 can fit with each other, avoiding causing abnormal effects on adjacent magnet assemblies 22, which may lead to abnormal operation of the motor.

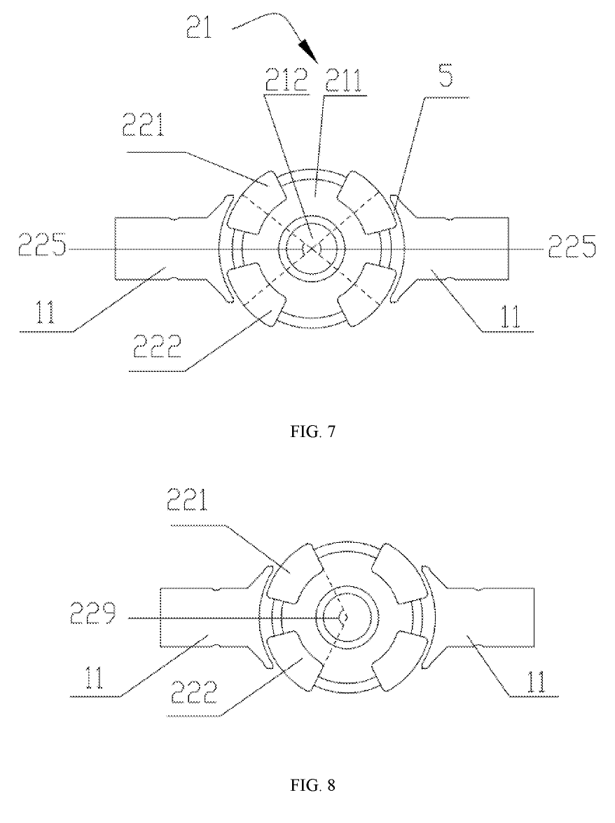

FIG. 7 is a schematic structural diagram of a third angle according to an embodiment of the present disclosure. As shown in FIG. 7, in the embodiments of the present disclosure, within a plane perpendicular to an axis of rotation of the rotor assembly 2, an angle between a centerline of the first magnet 221 and a centerline of the second magnet 222 may be a third angle 225. The centerline of the first magnet 221 may be a line pointing from the center of the first magnet 221 to the axis of rotation; and the centerline of the second magnet 222 may be a line pointing from the center of the second magnet 222 to the axis of rotation. The axis of rotation may be a centerline of the power shaft 21, and it is to be understood that the axis of rotation is also a centerline of the output shaft 212. The centerline of the first magnet 221 may be perpendicular to the axis of rotation; and the centerline of the second magnet 222 may also be perpendicular to the axis of rotation. The third angle 225 may range from 73° to 87°. Specifically, the third angle 225 may be set to 75°, 79°, 83°, or 85°, etc. In practical applications, the size of the third angle 225 may also be set on the basis of actual needs, which is not specifically limited herein.

FIG. 8 is a schematic structural diagram of a fifth angle according to an embodiment of the present disclosure. As shown in FIG. 8, in the embodiments of the present disclosure, an angle formed by two outer boundaries of the magnet assembly 22 extending to the axis of rotation of the rotor assembly 2 may be a fifth angle 229, and the fifth angle 229 may range from 122° to 141°. Specifically, the fifth angle 229 may be 127°, 127.5°, or 136°. The above angle range may enable one group of magnet assemblies 22 to occupy a relatively reasonable proportion on the power shaft 21. It is avoided that one group of magnet assemblies 22 occupies a larger proportion on the power shaft 21 because this may cause the rotor assembly 2 to be unable to oscillate back and forth. Furthermore, it is avoided that one group of magnet assemblies 22 occupies a smaller proportion on the power shaft 21 because this may reduce the degree of fit between the rotor assembly 2 and the stator assembly 1 and may cause the rotor assembly 2 to be unable to properly operate.

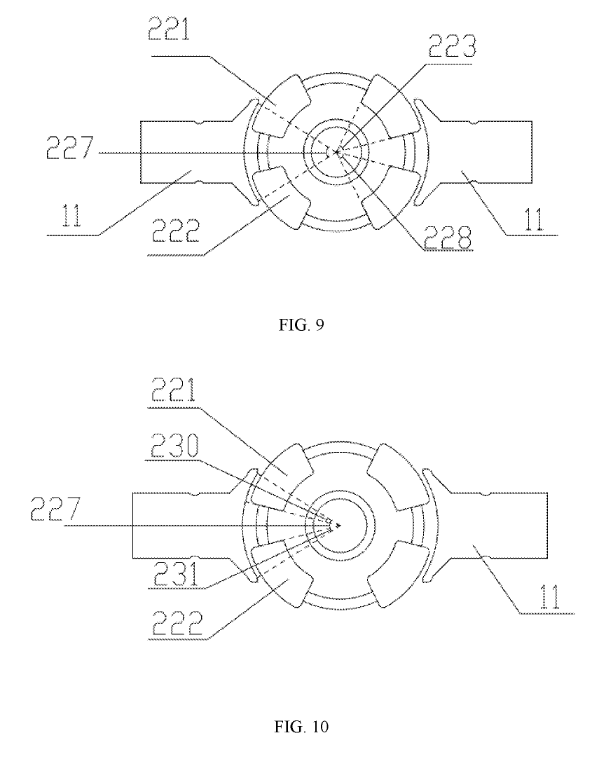

FIG. 9 is a schematic structural diagram of a second central angle according to an embodiment of the present disclosure. As shown in FIG. 9, in the embodiments of the present disclosure, within the plane perpendicular to the axis of rotation of the rotor assembly 2, a ratio of the first central angle 223 corresponding to the outside circular arc 2211 of the first magnet 221 facing the stator core 11 to the second central angle 227 corresponding to an inner circular arc of the stator core 11 facing the magnet assembly 22 may range from 60% to 85%, and a ratio of the third central angle 228 corresponding to the outside circular arc 2211 of the second magnet 222 facing the stator core 11 to the second central angle 227 corresponding to the inner circular arc of the stator core 11 facing the magnet assembly 2 may also range from 60% to 85%. In addition, when the shape, the size, and the structure of the second magnet 222 are the same as those of the first magnet 221, the size of the third central angle 228 corresponding to the outside circular arc 2211 of the second magnet 222 facing the stator core 11 is the same as the size of the first central angle 223. By setting a reasonable range of the ratio of a central angle corresponding to the outside circular arc 2211 of a single magnet to the second central angle 227 corresponding to the inner circular arc of the stator core, the cogging torque may be reduced, the swing angle may be increased, and the vibration frequency of the motor may be lowered.

In practical applications, it is also feasible to reduce the cogging torque and increase the swing angle by setting a reasonable range of a ratio of an arc length of the outside circular arc 2211 of a single magnet to an arc length of the inner circular arc of the stator core 11. Specifically, within the plane perpendicular to the axis of rotation of the rotor assembly 2, the ratio of the arc length of the outside circular arc 2211 of the first magnet 221 facing the stator core 11 to the arc length of the inner circular arc of the stator core 11 facing the magnet assembly 22 may range from 60% to 70%; and the ratio of the arc length of the outside circular arc 2211 of the second magnet 222 facing the stator core 11 to the arc length of the inner circular arc of the stator core 11 facing the magnet assembly 22 may also range from 60% to 70%. The arc length of the inner circular arc of the stator core 11 facing the magnet assembly 22 may include a chamfered portion of the stator core 11, or may not include the chamfered portion of the stator core 11, and the specific situation may be set on the basis of actual construction requirements of the motor.

FIG. 10 is a schematic structural diagram of a fourth central angle according to an embodiment of the present disclosure. As shown in FIG. 10, in the embodiments of the present disclosure, when the rotor assembly 2 is at the balanced position, the first magnet 221 and the second magnet 222 are respectively positioned on two sides of the stator core 11. Central projections of the first magnet 221 and the stator core 11 in the radial direction have partially overlapping regions, and central projections of the second magnet 222 and the stator core 11 in the radial direction also have partially overlapping regions. A ratio of a fourth central angle 230 corresponding to a projection overlapping portion of the first magnet 221 and the stator core 11 to half of the second central angle 227 corresponding to the inner circular arc of the stator core 11 facing the magnet assembly 22 may range from 40% to 70%; and/or, a ratio of a fifth central angle 231 corresponding to a projection overlapping portion of the second magnet 222 and the stator core 11 to half of the second central angle 227 corresponding to the inner circular arc of the stator core 11 facing the magnet assembly 22 may also range from 40% to 70%. The fourth central angle 230 is equal to the fifth central angle 231. The central projections may be projections of the first magnet 221, the second magnet 222, and the stator core 11 made with one point on the axis of rotation as a projection center when the rotor assembly 2 is at the balanced position.

During actual construction of the motor, a width of the air gap 5 between the outside circular arc 2211 of the first magnet 221 or the second magnet 222 and the inner circular arc of the stator core 11 facing the magnet assembly 22 may range from 0.15 millimeters to 0.25 millimeters, which may improve the degree of degree of fit between the rotor assembly 2 and the stator assembly 1 without adversely affecting the normal operation of the rotor assembly 2.

As another implementation, the ratio of the fourth central angle 230 corresponding to a projection overlapping portion of the first magnet 221 and the stator core 11 to the first central angle 223 corresponding to the outside circular arc 2211 of the first magnet 221 facing the stator core 11 may be a first ratio, which may range from 30% to 45%. The ratio of the fifth central angle 231 corresponding to a projection overlapping portion of the second magnet 222 and the stator core 11 to the third central angle 228 corresponding to the outside circular arc 2211 of the second magnet 222 facing the stator core 11 may be a second ratio, which may also range from 30% to 45%. In addition, when the shape, the size, and the structure of the second magnet 222 are the same as those of the first magnet 221, and the first magnet 221 and the second magnet 222 are symmetrically arranged along a horizontal axis, the size of the fifth central angle 231 is equal to that of the fourth central angle 230, and the first ratio is equal to the second ratio. The first ratio and the second ratio may be values such as 35%, 37%, and 40%, to improve the degree of fit between the stator core 11 and the magnet assembly 22.

In the embodiments of the present disclosure, the electromagnetic coil 4 may respond to the control signal applied to the electromagnetic coil 4. At this moment, the stator core 11 may allow the rotor assembly 2 to rotate around the axis of rotation relative to the stator core 11. An angle of unidirectional rotation of the rotor assembly 2 around the axis of rotation relative to the stator core 11 may range from 0° to 20°; and correspondingly, An angle of bidirectional rotation of the rotor assembly 2 around the axis of rotation relative to the stator core 11 may range from 0° to 40°. A larger swing angle helps meet tooth cleaning requirements of different consumers. In addition, a frequency of the motor during operation ranges from 100 Hz to 180 Hz. Further, the motor may normally operate stably between 140 Hz and 150 Hz. Reducing the vibration frequency of the motor can prevent the user from suffering from uncomfortable feelings such as toothache or tooth acid caused by high-frequency vibration, and can also avoid increase in motor noise caused by the high-frequency vibration, thereby improving user experience in using the oral cleaning device provided with the motor.

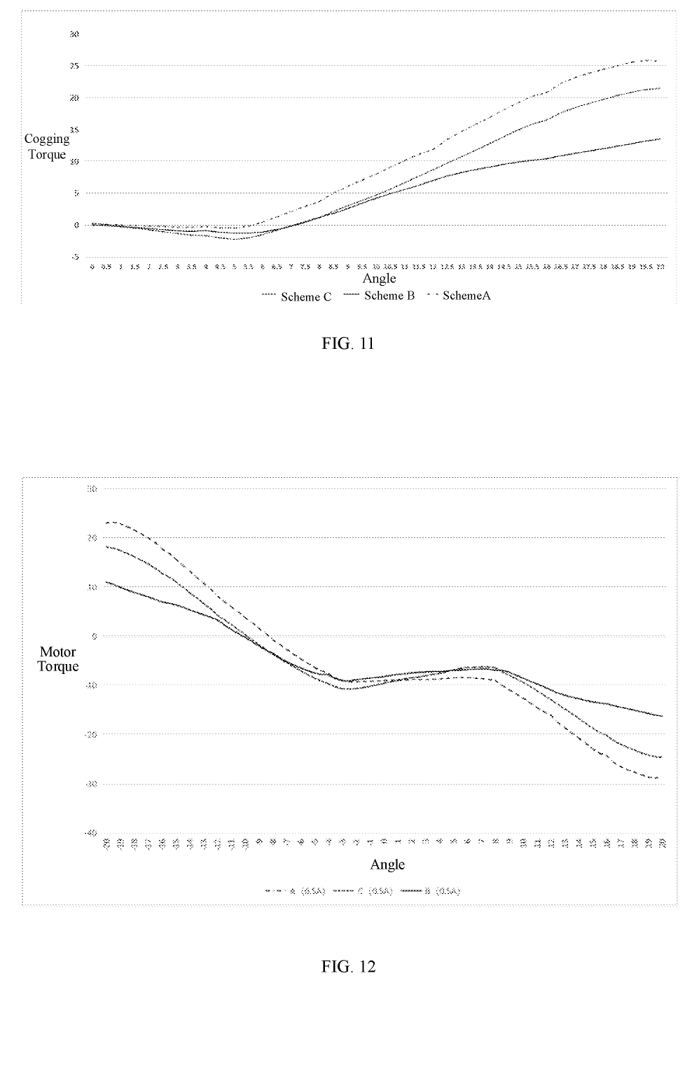

FIG. 11 is a schematic diagram of distribution of simulation data of the cogging torque of the motor according to an embodiment of the present disclosure; and FIG. 12 is a schematic diagram of distribution of simulation data of a motor torque according to an embodiment of the present disclosure. Specific parameters of a test sample in FIG. 11 and FIG. 12 are as follows.

Scheme A is represented by a dot dash line in FIG. 11 and a dot dash line in FIG. 12. The central angles corresponding to the first magnet 221 and the second magnet 222 in the magnet assembly are both 49.5°, that is, the central angles corresponding to the outside circular arc 2211 and the inside circular arc 2212 of the first magnet 221 and the second magnet 222 are both 49.5°. The second angle 224 between the first magnet and the second magnet is 28.5°. The thickness of the magnet is set to be 1.5 millimeters. The depth of the mounting slot is set to be 0.7 millimeter. The fourth angle 226 between the two magnet assemblies 22 is set to be 52.5°.

Scheme B is represented by a solid line in FIG. 11 and a solid line in FIG. 12. The central angles corresponding to the first magnet 221 and the second magnet 222 in the magnet assembly are both 45°, that is, the central angles corresponding to the outside circular arc 2211 and the inside circular arc 2212 of the first magnet 221 and the second magnet 222 are both 45°. The second angle 224 between the first magnet 221 and the second magnet 222 is 37°. The thickness of the magnet is set to be 1.5 millimeters. The depth of the mounting slot is set to be 0.7 millimeter. The fourth angle 226 between the two magnet assemblies 22 is set to be 53°.

Scheme C is represented by a dashed line in FIG. 11 and a dashed line in FIG. 12. The central angles corresponding to the first magnet 221 and the second magnet 222 in the magnet assembly are both 54°, that is, the central angles corresponding to the outside circular arc 2211 and the inside circular arc 2212 of the first magnet 221 and the second magnet 222 are both 54°. The second angle 224 between the first magnet 221 and the second magnet 222 is 28°. The thickness of the magnet is set to be 1.5 millimeters. The depth of the mounting slot is set to be 0.7 millimeter. The fourth angle 226 between the two magnet assemblies 22 is set to be 44°.

It is to be understood that as a rotation angle of the rotor assembly 2 in the motor changes, the cogging torque of the motor also changes. FIG. 11 is used for illustrating a relationship between the cogging torque of the motor and the rotor assembly 2 in the motor. In FIG. 11, an abscissa may represent the rotation angle of the rotor assembly 2 in the motor; and an ordinate may represent the cogging torque corresponding to the rotation angle of the rotor assembly 2.

For the motor used in the oral cleaning device such as an electric toothbrush, the electromagnetic torque and the cogging torque resist each other during swinging of the motor. By reducing the cogging torque, it is beneficial to increase the swing angle under the equivalent electromagnetic torque, and lower a resonance point frequency. Simulation testing is performed on the motor in the embodiments of the present disclosure. FIG. 12 shows experimental data obtained under a load of 0.5 A forward current, where an abscissa represents the rotation angle of the rotor assembly, and an ordinate may represent the motor torque. From the diagram of distribution of the simulation data of the motor torque shown in FIG. 12 and the diagram of distribution of the simulation data of the cogging torque shown in FIG. 11, it may be seen that in the Scheme A, a zero position torque is 9.03 mN.m, and an NR position is 8.04°; in the Scheme B, the zero position torque is 8.23 mN.m, and the NR position is 9.71°; and in the Scheme C, the zero position torque is 9.6 mN.m, and the NR position is 9.16°. On this basis, the zero position torque of the motor in the embodiments of the present disclosure is low, this is because the modified electromagnetic structure significantly reduces the cogging torque, and also has a certain impact on a starting torque at the balanced position. When the NR position angle increases, that is, at a position angle where the electromagnetic torque and the cogging torque cancel out to zero, this is conducive to a larger swing angle and a lower resonance frequency.

In the embodiments of the present disclosure, when the motor is in a no-load state of I=0 A, a rotor is stationary at a zero position, and there is no output torque. When a positive current is applied, the rotor assembly 2 generates a zero position torque in a negative direction, and rotates in this direction until the rotor assembly reaches a position where a natural return (NR) output torque is equal to 0 Nm, and then shifts towards a positive direction. Afterwards, if the current is maintained in the forward direction, the rotor assembly will rotate backwards around the NR position and stop at a preset NR position. If a negative current is applied, the rotation direction of the rotor assembly 2 may be opposite to the rotation direction when the positive current is applied. In this way, the rotor assembly 2 in the motor is caused to perform a reciprocating motion by applying an alternating current.

For convenience of description, spatially relative terms, such as “above”, “over”, “on an upper surface of”, “on” and the like, may be used herein to describe a spatial position relationship between one device or feature shown in the figure and other devices or features. It should be understood that the spatially relative terms are intended to encompass different orientations in use or operation other than the orientation of the device described in the figures. For example, if the device in the drawings is inverted, the device described as “above other devices or structures” or “over other devices or structures” will be oriented as “below other devices or structures” or “under other devices or structures”. Thus, the exemplary term “above” may include two orientations: “above” and “below”. The device may be otherwise oriented (rotated 90 degrees or at other orientations) and the spatially relative descriptors used herein interpreted accordingly.

It is to be noted that the terms used herein are only for the purpose of describing the specific embodiments, and are not intended to limit the exemplary embodiments according to the present disclosure. As used herein, the singular forms are intended to include the plural forms unless the context clearly dictates otherwise. In addition, it should be understood that when the terms "including" and/or "comprising" are used in this specification, they indicate the presence of features, steps, operations, devices, components, and/or combinations thereof.

It should be explained that in the specification, the claims and the foregoing accompanying drawings of the present disclosure, a term such as a first or a second is intended to separate between similar objects but is not intended to describe a specific sequence or precedence order.

The embodiments described above are only illustrated as embodiments of the present disclosure, and are not intended to limit the present disclosure. To those skilled in the art, various modifications and variations may be available for the present disclosure. All modifications, equivalent substitutions and improvements made within the spirit and principle of the present disclosure shall fall within the protection scope of the claims of the present disclosure.

What is claimed is:

1. A motor used in an oral cleaning device, the motor comprising a stator assembly and a rotor assembly; wherein
the stator assembly is configured to generate a magnetic field, and the stator assembly comprises at least one pair of stator cores uniformly distributed in a circumferential direction;
the rotor assembly is at least partially arranged within the magnetic field of the stator assembly, and the rotor assembly comprises a power shaft and magnet assemblies arranged on the power shaft and matching the stator cores;
the stator cores are configured to drive, in an energized state, the rotor assembly to oscillate back and forth at a predetermined angle; in a de-energized state, the rotor assembly is configured to have a rotatable angle greater than 360° when being subjected to an external force; and
the rotor assembly has a balanced position matching the stator cores and an unbalanced position deviating from the stator cores; and at the unbalanced position, the rotor assembly is configured to reset to the balanced position under an action of a cogging torque after the external force is removed.

2. The motor according to claim 1, wherein number of the balanced positions is configured to correspond to number of the stator cores; the balanced position at least comprises a first balanced position and a second balanced position corresponding to one pair of stator cores, respectively; and
when at the unbalanced position, the magnet assemblies are configured to reset towards the first balanced position or the second balanced position having a minimum angle according to an angle between a current position and the first balanced position or the second balanced position.

3. The motor according to claim 1, wherein the stator assembly comprises two of the stator cores, the two stator cores being mirror-symmetrical; and the rotor assembly comprises two groups of magnet assemblies, the two groups of magnet assemblies being mirror-symmetrical.

4. The motor according to claim 1, wherein an angle between the first balanced position and the second balanced position is configured to be a first angle, and the first angle ranges from 180°-3° to 180°+3°.

5. The motor according to claim 1, wherein the magnet assemblies comprise a first magnet and a second magnet, and the first magnet and the second magnet are spaced apart on the power shaft.

6. The motor according to claim 5, wherein the first magnet and the second magnet are both in a circular arc shape, comprising an outside circular arc and an inside circular arc distributed in a radial direction, and two side edges connecting two corresponding ends of the outside circular arc and the inside circular arc, respectively.

7. The motor according to claim 6, wherein the first magnet and the second magnet are arranged along a circumferential direction of the power shaft, a central angle corresponding to a spacing between the first magnet and the second magnet is a second angle, and the second angle ranges from 23.5° to 38°.

8. The motor according to claim 6, wherein within a plane perpendicular to an axis of rotation of the rotor assembly, a third angle between a centerline of the first magnet and a centerline of the second magnet ranges from 73° to 87°; the centerline of the first magnet is a centerline pointing from a center of the first magnet to the axis of rotation of the rotor assembly, and the centerline of the second magnet is a centerline pointing from a center of the second magnet to the axis of rotation.

9. The motor according to claim 6, wherein within a plane perpendicular to an axis of rotation of the rotor assembly, a ratio of a first central angle corresponding to the outside circular arc of the first magnet facing the stator core to a second central angle corresponding to an inner circular arc of the stator core facing the magnet assembly ranges from 60% to 85%.

10. The motor according to claim 6, wherein within a plane perpendicular to an axis of rotation of the rotor assembly, a ratio of a third central angle corresponding to the outside circular arc of the second magnet facing the stator core to a second central angle corresponding to an inner circular arc of the stator core facing the magnet assembly ranges from 60% to 85%.

11. The motor according to claim 2, wherein the motor further comprises an output shaft, and one end of the output shaft is connected to a brush head of an electric toothbrush.

12. An oral cleaning device, wherein the oral cleaning device is provided with the motor according to claim 1.
